(19) United States
(12) Patent Application Publication
(10) Pub. No.: US 2025/0259273 A1
(43) Pub. Date: Aug. 14, 2025

(54) AUTOMATED RECTIFICATION OF GEO-INACCURACY IN COMMERCIAL SATELLITE IMAGERY

(71) Applicant: Shin-yi Hsu, Menands, NY (US)

(72) Inventor: Shin-yi Hsu, Menands, NY (US)

(21) Appl. No.: 19/054,286

(22) Filed: Feb. 14, 2025

Related U.S. Application Data
(60) Provisional application No. 63/553,633, filed on Feb. 14, 2024.

(51) Int. Cl. G06T 5/50; G06T 5/73; G06T 7/00; G06T 7/30

(52) U.S. Cl. CPC G06T 5/50; G06T 5/73; G06T 7/0002; G06T 7/30; G06T 2207/10036; G06T 2207/20016; G06T 2207/20221; G06T 2207/30181

(57) ABSTRACT

Methods are provided for automated rectification of geo-inaccuracy in commercial satellite imagery, and for reducing multi-orbit imagery shift/offset/drift using automated orthorectification to isolate terrain elevation derived drift. At least two images are obtained, a base image for scene registration and an orthorectified image with a corresponding digital elevation model (DEM) in a Virtual Earth Coordinate (VEC), where the orthorectified image is registered with the base image to produce a registered image set to produce geographical imagery having a near zero drift level.

### CROSS-REFERENCE TO RELATED APPLICATION(S)

The present application claims priority from U.S. Provisional Application 63/553,633, filed on Feb. 14, 2024, which is incorporated herein by reference in its entirety.

### FIELD OF THE DISCLOSURE

The present invention relates to automated rectification of geo-inaccuracy in commercial satellite imagery, and more particularly to reducing multi-orbit imagery shift/offset/drift using automated orthorectification to isolate terrain elevation derived drift and thus partitioning total drift component to terrain effect, off-nadir degree difference and residual drifts. This approach provides an alternative to conventional least square methods for error estimation.

### BACKGROUND INFORMATION

Goodness-of-fit assessment of geolocation accuracy has been previously performed using two general approaches: (1) at a point location; and (2) at a region of interest (ROI); and (3) at a scene level in a geospatial scale continuum. The first approach is described in the European Space Agency study of WorldView-3 imagery at La Crau, France where the topography of La Crau does not exceed 190 m above the reference ellipsoid. (Sébastien Saunier, Sultan Kocaman Fay Done: EDAP.REP.031 Issue: 1.0 29 06 2022).

The second approach was used in a study by NASA related investigators on Advanced Very High Resolution Radiometer (AVHRR) Global Area Coverage (GAC) data having a spatial resolution of 1 km. This study introduced the concept of geo-inaccuracy called “shift” by comparing AVHRR data with MOD13A1 (V006) reference data at a region of interest (ROI). The ROI is a “patch” of 7×7 AVHRR pixels corresponding to 28 km by 28 km as the spatial base. (Xiaodan Wu, Kathrin Naegeli, and Stefan Wunderie: Earth Syst. Sci. Data 12, 539-553, 2020). The authors present a correlation-based patch matching method (CPMM) to quantify geo-location accuracy at a sub-pixel level for coarse-resolution satellite data. In addition, the authors identify spatial shifts in cross-track (x) and along-track (y) directions, and suggested numerous possible factors that can influence the observed shift magnitudes ranging from <1 km to 6 km, including terrain, satellite zenith angles (satZs), etc.

Accordingly, it is desirable to have a more accurate geo-location system and method that can better account for sources of geo-location errors such as, e.g., terrain effects, off-nadir imaging difference effects, and residual effects.

### SUMMARY OF THE DISCLOSURE

Embodiments of the disclosure can provide systems and methods that improve geolocation accuracy based on satellite and/or aerial imagery of 3D terrains, and reduce errors from various sources. Geolocation accuracy can be measured by creating networks of groundtruth points and measuring the difference between images. MAXAR WV and Pleiades NEO imagery geolocation accuracy is 3.5 m (CE90). This level of accuracy can be degraded to >100 m by terrain elevation and/or off-nadir differences. On flat terrain, the offset can be <12 m.

Three sources of geolocation inaccuracy include: a) terrain effects; b) off-nadir imaging difference effect; and c) residual effects. Terrain and residual effect errors can be isolated using an orthorectification technique, leaving off-nadir effects as the difference between combined terrain/residual effects and the total geolocation inaccuracy. Georectification using high-resolution aerial DOQQ applied to satellite WV imagery can reduce groundpoint location offset to near zero. If the input image pair used for georectification is DOQQ and WV or Pleiades NEO imagery, the resulting modified WV/Pleiades image has equivalent geoaccuracy as the DOQQ.

In one embodiment, a method of reducing multi-orbit drift of satellite geographical imagery to a near zero level can be provided. The method can facilitate automated rectification of geo-inaccuracy in commercial satellite imagery by first obtaining at least two images, one of the images being a base image for scene registration. At least one orthorectified image can then be generated with a corresponding digital elevation model (DEM) in a Virtual Earth Coordinate (VEC). The orthorectified image can then be registered with the base image to produce a registered image set, and the georegistered imagery can then be outputted with scene content signature. The image registration can be generated by casting a database representing a set of control points over a full scene in a hierarchical order with at least one level. This georegistered imagery can be used for, e.g., updating USGS digital orthophoto quarter-quadrangle (DOQQ) data, updating Landsat 15 m panchromatic data, or providing multi-resolution, multi-sensor data fusion.

In further embodiments, the registering of the image can be automated with at least one aligned imagery being zero drift imagery covering a fraction of the full scene, imagery having between zero and 1-pixel distance drift covering another fraction of the full scene, or imagery that leaves a small fraction of the full scene for an Others classification.

In further embodiments, a method of implementing improved orthorectification of satellite and/or aerial imagery can be provided. This method includes the steps of: inputting imagery representing a full scene; providing digital elevation model (DEM) data and corresponding rational polynomial coefficients (RPC) data corresponding to the scene; and generating an orthorectified image by casting data corresponding to the satellite or aerial imagery onto a DEM surface. Optionally, non-ortho drift data can also be generated for the satellite and/or aerial imagery in csv form, and a distribution of the non-ortho drift data can be displayed in a plot having x-axis coordinates corresponding to a direction of drift, and y-axis coordinates corresponding to a magnitude of the corresponding non-ortho drift data. In another embodiment, a further orthorectified image can be generated based on a further imagery of the scene, and ortho drift data can then be generated in csv form based on a comparison of the orthorectified image and the further orthorectified image. The distribution of the ortho drift data can then be displayed in a plot having x-axis coordinates corresponding to a direction of drift, and y-axis coordinates corresponding to a magnitude of the corresponding non-ortho drift data.

In still further embodiments, a method for updating DOQQ using commercial satellite imagery can be provided. This method can include obtaining a DOQQ imagery as a base image, obtaining a high-resolution form of the commercial imagery as an aligned image, obtaining digital elevation model data corresponding to the aligned image, and obtaining rational polynomial coefficient data for the aligned image. Imagery registration can then be performed using the base image, the digital elevation model data, and the rational polynomial coefficient data to reduce a drift between the base image and the aligned image to a near zero level. The resulting image registration data can then be used to update the DOQQ between DOQQ acquisition cycles.

In still further embodiments, a method can be provided for fusing multi-resolution geographic imagery and multi-sensor geographic imagery data. This method includes the steps of georegistering low-resolution geographic imagery with high-resolution geographic imagery to obtain a georegistered imagery pair, wherein the low-resolution geographic imagery and the high-resolution geographic imagery correspond to a same region. This georegistered imagery pair can then be used as base image and an aligned image to reduce a drift between the base image and the aligned image to a near-zero level. The resulting near-zero-drift low-resolution imagery can be sharpened using the high-resolution geographic imagery as a pan band, and low-resolution bands as red, green, blue and NIR bands to obtain sharpened low-resolution geographic imagery. An image displaying the sharpened low-resolution geographic imagery can then be generated based on the image processing results. In this method, the low-resolution geographic imagery can be low-resolution satellite or aerial imagery, and the high-resolution geographic imagery can be high-resolution satellite or aerial imagery.

In yet another embodiment, a method of performing scene content analysis to complement between nonliteral exploitation and literal exploitation of multi-spectral and hyperspectral imagery can be provided. This method includes georegistering and sharpening a low-resolution imagery between multi-orbit satellite imagery having drift reduced to near zero, and performing scene content analysis to optimize a plurality of complementing scene content signatures. Characteristics of scene content signatures for both the sharpened low-resolution imagery and the original low-resolution image with higher spectral bands can be compared, and complementary scene content signatures for both the sharpened low-resolution imagery and the original low-resolution image having higher spectral bands can then be outputted. Each of the scene content signatures can optionally be produced by an analysis that includes conventional fuzzy set methodology or a managed fuzzy set methodology based on a specific region of interest. Spectral signatures or membership scenes for the scene content signatures can then optionally be provided in a form of a mapping function. In another embodiment, at least one subsystem used to generate the scene content signatures includes a number of bands to be analyzed, a number of iterations used, a particular signature to be extracted, a scene signature grown from an original setting, a number of signatures in each growing stage, a duplicate signature identifier, a fuzzy membership, a region of interest to be included in the scene content analysis, a convergence parameter, or a noise parameter.

Results of certain embodiments of the methods described herein have been verified by using the georectified WV and Pleiades NEO imagery to replace DOQQ as base/reference imagery, yielding an output that is virtually identical to the original output. Accordingly, georectified or aligned WV or Pleiades NEO imagery obtained with embodiments of the present disclosure can be used to update DOQQ, and also to perform multi-resolution, multi-sensor data fusion.

### BRIEF DESCRIPTION OF THE DRAWINGS

Further objects, features and advantages of the disclosure will become apparent from the following detailed description taken in conjunction with the accompanying figures showing illustrative examples, results and/or features of the exemplary embodiments of the present disclosure, in which:

FIG. 1 shows select data point parameters and dataplots of geospatial drift characteristics for a WV-2 P007 Scene in Oakland, CA as conventionally compared with DOQQ data;

FIG. 2 shows select comparison data point parameters and dataplots of geospatial drift characteristics for the scene of FIG. 1 after applying the orthorectification methods in accordance with embodiments of the disclosure;

FIG. 3A is a plot of drift magnitude vs. direction in a conventional comparison of WV3 2019 June image data with DOQQ non-ortho data for the scene of FIG. 1, exhibiting two peaks;

FIG. 3B is a plot of drift magnitude vs. direction in a conventional comparison of WV3 2019 June image data with DOQQ image data for the scene of FIG. 1, after applying the orthorectification methods in accordance with embodiments of the disclosure to the DOQQ data, exhibiting one peak;

FIG. 4A is a plot of drift magnitude vs. direction in a conventional comparison of Pleiades_NEO_2022 image data with DOQQ non-ortho data for the scene of FIG. 1, exhibiting two peaks;

FIG. 4B is a plot of drift magnitude vs. direction in a conventional comparison of Pleiades_NEO_2022 image data with DOQQ image data for the scene of FIG. 1, after applying the orthorectification methods in accordance with embodiments of the disclosure to the DOQQ data, exhibiting one large peak and one small peak;

FIG. 5 shows select data point parameters and a dataplot of geospatial drift characteristics for a conventional comparison of DOQQ image data with Pleiades NEO image data corresponding to ID #IMG_PNEO4_202304261914545_MS-FS_SEN_PWOI_000110172_1_1_F_1_NED_R1C1.TIF;

FIG. 6 shows select data point parameters and a dataplot of geospatial drift characteristics for a comparison of DOQQ image data with WV3 image data corresponding to ID #19JUN18191335-M2AS_R1C1-014140375010_01_P001.TIF, after applying the orthorectification methods in accordance with embodiments of the disclosure;

FIG. 7 is a table of percent coverage of drift levels for four sets of WV3 image data, where each set of WV3 data is compared to DOQQ data and to WV3 19JUN data after it has been automatically georegistered to DOQQ data in accordance with embodiments of the disclosure;

FIG. 8 shows 30 m resolution Landsat imagery of a region in Oakland, CA;

FIG. 9 shows 1 m resolution WV3 imagery of the same region in FIG. 8;

FIG. 10 shows Landsat imagery of the same region in FIGS. 8 and 9 after it has been sharpened to 1 m resolution in accordance with embodiments of the disclosure;

FIG. 11A shows a magnified image of a portion of the image in FIG. 8 having 30 m resolution;

FIG. 11B shows a magnified image of the same area of FIG. 11 after it has been sharpened to 1 m resolution;

FIG. 12 is a table of distinct spectral signature IDs obtained from the sharpened image of FIG. 10;

FIG. 13 is a table of distinct spectral signature IDs obtained from the original Landsat imagery of FIG. 8;

FIG. 14A is an exemplary image showing drift data before iMaG AGR automated drift rectification;

FIG. 14B is an exemplary image showing drift data after iMaG AGR automated drift rectification for the same region shown in FIG. 14A;

FIG. 15 is an exemplary image showing ICeye drift data before iMaG AGR automated drift rectification; and

FIG. 16 is an exemplary image showing ICeye drift data after iMaG AGR automated drift rectification for the same region shown in FIG. 15.

The various embodiments of the disclosure are described herein with reference to the figures, where like reference numbers indicate identical or functionally similar elements. Further features and advantages of the disclosure as well as the structure and operation of various embodiments of the present disclosure are described in detail below with reference to the accompanying drawings. To the extent that the present disclosure does reference the figures, it is done so in connection with the illustrative embodiments and is not limited by the particular embodiments illustrated in the figures. It is intended that changes and modifications can be made to the described embodiments without departing from the true scope and spirit of the present disclosure.

### DETAILED DESCRIPTION OF EXEMPLARY EMBODIMENTS

Embodiments of the present disclosure can provide improved systems and methods for reducing geo-inaccuracy in commercial satellite imagery. In particular, multi-orbit imagery shift/offset/drift can be reduced using automated orthorectification to isolate terrain elevation derived drift and thus partitioning a total drift component to terrain effect, off-nadir degree difference and residual drifts. The disclosed systems and methods include differentiating non-ortho two-peak full scene drift data from the corresponding ortho-based single-peak drift data distribution, and is advantageous for isolating and visualizing the effects of terrain elevation influence over drift data.

In one example, a full-scene image of 8000 by 5000 pixels is used as an input, corresponding to approximately 66 km by 66 km, to assess the geolocation discrepancy between WV3/Pleiades NEO imagery at a 1 m resolution level against the U.S. Geological Survey's (USGS's) digital orthophoto quarter-quadrangle (DOQQ) as the base image at two sites: (1) Oakland, CA with mountainous, hilly, and Urban terrain, and (2) Syracuse, NY with mostly flat terrain. To assess both accuracy and inaccurate distribution across the entire scene, a network of 4096 and 16,384 or more control points were used. The concept of the spatial distribution of drift/shift from across-track and along-track with only two directions is expanded to 360 directions with corresponding magnitude measurements in the non-ortho domain that constitutes the entirety of drifts with varying influencing factors including terrain, off-nadir degree difference, real changes between two multi-orbit periods and other sources of drift.

The terrain elevation drift and off-nadir degree difference drifts are typically intertwined. To separate them, a novel orthorectification method is introduced that puts the image coordinate pixels onto the digital elevation model (DEM) coordinates with the corresponding rational polynomial coefficients (RPC) data. This coordinate transform isolates the terrain drift from off-nadir component drift. In two-dimensional data plots with drift direction as the x-axis and drift magnitude as the y-axis, the original non-ortho drift exhibits two or more peaks, whereas the orthorectification-based ortho data becomes one peak, representing only the terrain effect by eliminating the other drift effects.

The drift can also be reduced to a near zero level by an image-to-image matching methodology to match the WV3/Pleiades NEO imagery against a DOQQ base with government-verified geolocation accuracy of 7.6 m as a standard. A perfect match at a control point cell constitutes zero drift, and a 1-pixel offset drift is noted as the second level best match. In the present disclosure, a near zero drift is defined as having the following three components: (1)>40% zero drift, (2)<50% drift greater than 0 and less than 1 pixel, and (3)<10% drift as other components for change detection, etc.

After the total drift is reduced to near zero, the resulting output WV3/Pleiades NEO imagery is virtually the same as the input DOQQ geospatially. Therefore, it is now feasible to update DOQQ with the matched WV3 or Pleiades imagery because the production cycles of DOQQ is 2 years, 4 years, and 7 years. There is always the opportunity for the high-resolution commercial satellite imagery to update DOQQ and multi-resolution and multi-sensor data fusion after the full-scene imagery drifts are reduced to a near zero level.

In one example of this technique, using DOQQ as a reference, the full-scene drift data in Oakland, CA, where terrain covers mountain, hilly and urban areas, the drift/offset/shift data can be visualized under two conditions: (1) non-ortho, and (2) SRE iMaG AGR Ortho, or simply Ortho. When a network of 4096 and 16,384 or more control points are cast over a full scene of approximately 1 m 8000 by 5000 pixels, drift data can be visualized in varying directions with corresponding magnitudes. At each control point, drift can be summarized using a six-parameter setting as:
The x-coordinate
The y-coordinate
Drift in x-coordinate direction
Drift in y-coordinate direction
Direction of drift in 360-degree designation
Magnitude of drift in meters.

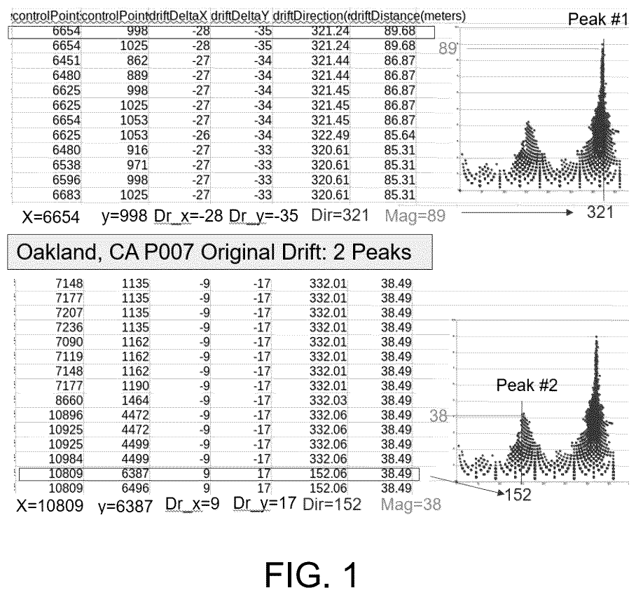

Using WV-2 P007 scene imagery versus DOQQ in Oakland, CA as an example, the two-peak geospatial drift characteristics for this imagery are shown in FIG. 1. The left six columns of FIG. 1 represent a partial listing of control points with their six corresponding numeric parameters. The first two columns are the x and y identifiers for a control point. The next two columns show the drift in the x and y directions, respectively, whereas the fifth and sixth columns indicate the drift direction and magnitude, respectively, at a control point. The two plots to the right of the table in FIG. 1 show the presence of two peaks in the drift direction (x-axis) vs. drift magnitude (y-axis). Here, the largest drift magnitude is observed at Peak #1 with a drift magnitude of 89 meters at a direction of 332 degrees, and a smaller peak at Peak #2 of 38 meters magnitude at a direction of 152 degrees.

In further embodiments, the methods and techniques described herein can be applied to Landsat 15 m panchromatic base images for image-to-image alignment in regions around the world, with DOQQ base images optionally being used for regions within the U.S.

There is often some confusion between orthorectification and georectification when conventional orthorectification is applied in the geospacial intelligence (GEOINT) domain. For example, conventionally, orthorectification is used to digitally align aerial or satellite imagery on a map surface using a near neighbor, or bilinear or cubic convolution algorithm. In contrast, orthorectification is the process of stretching the image to match the spatial accuracy of a map by accounting for location, elevation, and sensor information.

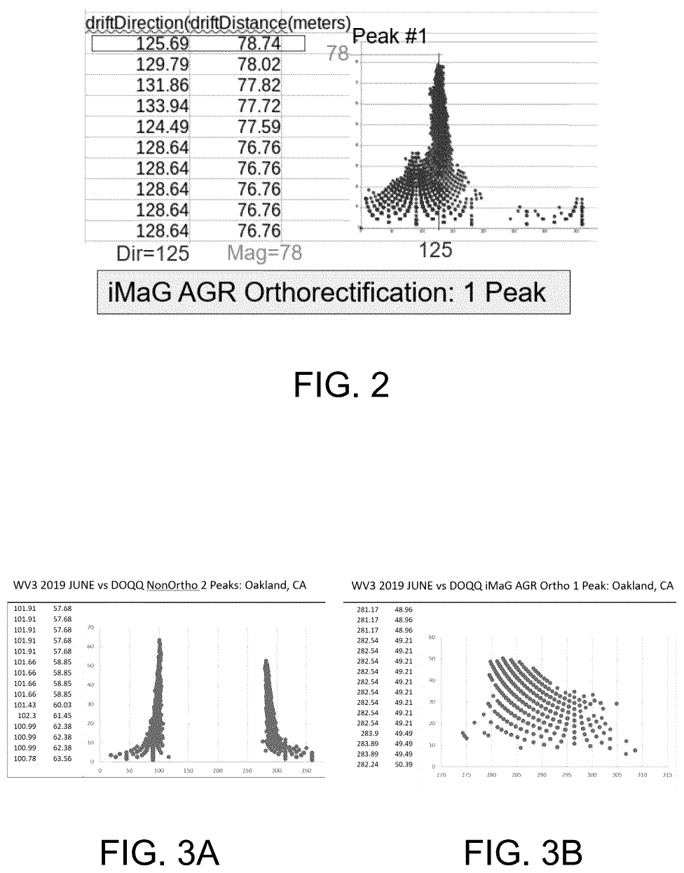

Essentially, orthorectification should be performed on top of a digital elevation model (DEM), and not directly on the map surface. Therefore, there is a need to generate a novel orthorectification on the DEM surface. The iMaG AGR orthorectification systems and methods described herein are based on a DEM surface. FIG. 2 shows some exemplary data obtained by applying the presently-disclosed orthorectification techniques on a DEM surface. In FIG. 2, data plotted as the drift direction (x-axis) vs. drift magnitude (y-axis) exhibits a single peak of about 78 m drift magnitude at a direction of about 125 degrees. It should be noted that in this orthorectification process, the magnitude of drift at the 128-drift direction is approximately 78 meters, whereas the original non-Ortho drift at the 125-drift direction is 38 meters. Therefore, in view of this difference, the iMaG AGR orthorectification process as described herein is not a technique for performing georectification on the map surface. Instead, orthorectification is used for rectification of geo-location on the DEM surface.

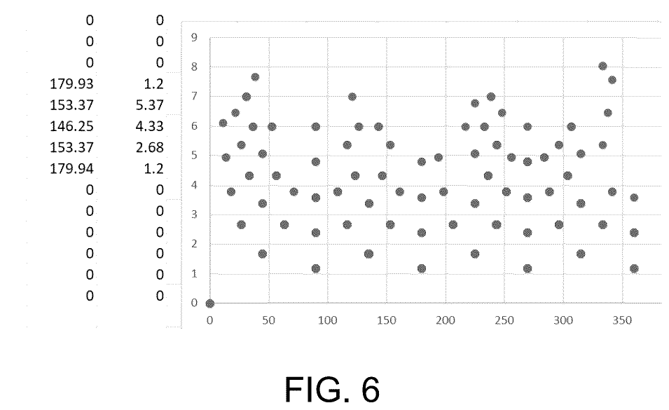

WV-3 and Pleiades NEO imagery are available for the example of the Oakland CA test site. It can be shown that the above non-Ortho drift vs iMaG AGR Ortho drift having a two-peak distribution (FIG. 1) vs. a one-peak distribution (FIG. 2) is generalizable from WV2 imagery to WV3 and Pleiades NEW imagery as shown in FIGS. 5 and 6.

FIG. 5A shows a conventional orthorectification data plot of direction (x) vs. drift magnitude (y) for WV3 and DOQQ non-Ortho data in the Oakland CA sample region. This data plot exhibits two distinct peaks in the drift magnitude. In contrast, data for the same region based on WV3 and the DOQQ iMaG AGR Ortho orthorectification technique, shown in FIG. 3B, exhibits a single, somewhat broader peak.

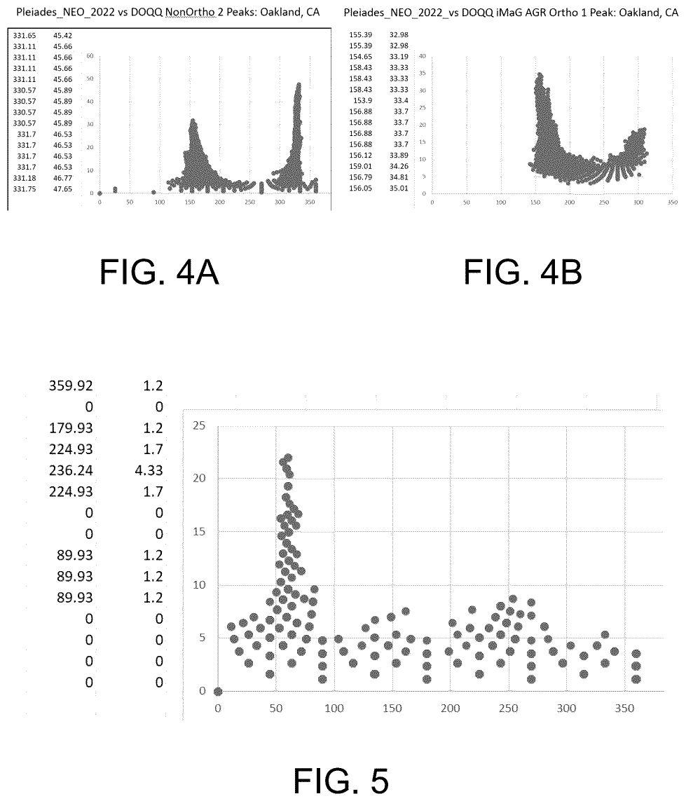

In a similar comparison, FIG. 4A shows a conventional orthorectification data plot of direction (x) vs. drift magnitude (y) for Pleiades_NEO_2022 data and DOQQ non-Ortho data in the same Oakland CA sample region. This data plot also exhibits two distinct peaks in the drift magnitude. Data for the same region based on Pleiades_NEO_2022 and the DOQQ iMaG AGR Ortho orthorectification technique, shown in FIG. 4B, exhibits a single prominent peak, along with a much smaller peak.

Indeed, the drift distribution patterns in drift direction and drift magnitude are similar between the WV3 imagery and the Pleiades NEO imagery (c.f. FIGS. 3 and 4) in spite of the fact that WV3 and Pleiades imagery are from US MAXAR satellites, whereas Pleiades NEW imagery is from Airbus, European satellites. The similarity in their characteristics are further shown in Table 1 below for WV2, WV3 and Pleiades NEO satellites.

TABLE 1
Characteristics of WV2, WV3 and Pleiades NEO Imagery of Oakland, CA

| Satellite | | | |
|---|---|---|---|
| Type | Imagery ID | Off-Nadir | Max Drift |
| WV2 | 15SEP22191310-M1BS- | 18.7 degrees | 63m |
| | 055062039010_01_P007.TIF | | |
| WV3 | 19JUN18191335-M2AS_R1C1- | 26 degrees | 64m |
| | 014140375010_01_P001.TIF | | |
| Pleiades | IMG_PNEO4_202304261914545_MS- | 29 degrees | 48m |
| NEO | FS_SEN_PWOI_000110172_1_1_F_1_NED_R1C1.TIF | | |

Table 1 shows that WV2, WV3 and Pleiades imagery have off-nadir-degree differences ranging from 18.7 degrees to 29 degrees. This suggests that the large magnitudes of drift are also influenced by off-nadir data which is different from zero from the DOQQ imagery. This also implies that if orthorectification is performed on the map surface, there will still be drift/offset arising from nonzero off-nadir-degree differences. This also means that conventional orthorectification cannot reduce drift or offset to zero when the off-nadir-degree differences are high.

Following the above discussion, it is also advantageous to isolate the sources of geo-inaccuracy further, where the three primary sources are the terrain effects, off-nadir imaging difference effects, and residual effects. Terrain effects and residual errors can be isolated by the presently-described orthorectification procedure that performs orthorectification on the DEM, leaving the extent of off-nadir imaging difference effects as the difference between total inaccuracy and the sum of terrain/residual effects. Therefore, to rectify geo-location, it is extremely advantageous to employ a unique image-to-image matching method to improve groundpoint location offset to near zero. Such near-zero offset can be defined as: (1) zero drift over at least 40% of the entire image; (2) offset between 0 and 1.2 m over an additional 50% of the image; and (3) a remainder of <10% of the total area for change detection.

This image-to-image matching requires the use of a base (or reference) image, for which the current DOQQ is a government image standard having 7.6 m accuracy. This accuracy level is extremely stable as verified by 3-year DOQQ acquisition cycles at Syracuse, New York for years 2013, 2017 and 2023.

The method for image-to-image matching is referred to herein as iMaG AGR georegistration. This method includes a series of sequential analyses including non-ortho georegistration, iMaG AGR orthorectification, and initial georegistration, as well as a final georegistration to reduce drift to a near zero level. Since this “near zero drift” as defined above is very small, there is virtually no difference between the base or reference image and the final matching image. Therefore, the final result of the present georegistration procedure can reliably replace the original input image. It is advantageous to define a “near zero drift” as a novel pedagogy in error estimation, to differentiate it from a conventional goodness-of-fit least-squares method.

In the United States, the DOQQ acquisition cycles range from 2 years, 4 years, and 7 years. Thus, there is always room to update to complement information during the mid-acquisition years. As one example, a summary of using Pleiades NEO imagery for DOQQ updating will now be presented. The Pleiades scenes ID are IMG_PNEO4_202304261914545_MS-FS_SEN_PWOI_000110172_1_1_F_1_NED_R1C1.TIF and IMG_PNEO4_202304261914545_MS_FS_SEN_PWOI_000110172_1_1_F_1_NED_R1C2. TIF. The scene R1C1 includes 7690 by 4254 pixels, and R1C2 has 816 by 4254 pixels. Therefore, for actual analysis, only the R1C1 scene will be used. The image-to-image matching results are as follows.
Zero drift covers 42.44% of the entire scene.
A drift of <=1.7 m (or one-pixel) covers 88.08% of the entire scene.
11.92% of the scene remains for change detection, etc.

The final drift database is shown for this analysis in FIG. 5 in a 2D plot. The database indicates that 88.02% of the entire scene is under the drift magnitude of 1.7 m, with 11.98% of the scene corresponding to other effects. The observed peak at about 60 degrees clearly belongs to the “other” category, having a maximum magnitude of 23 m. The rest of the drift values are substantially flat for all directions >100 degrees.

Based on the novel orthorectification techniques and image-to-image georegistration methods described herein to reduce multi-orbit scene drift to near zero, it is also advantageous to develop applications modules to address image processing issues that are more than a half-century old: (1) updating DOQQ with continuous imaging capabilities of commercial satellite imagery other than the current airborne imaging solutions; and (2) advancing image processing technologies in multi-resolution and multi-sensor data fusion where no current methods are capable of georegistering image resolution differences of 30 m versus 1 m that reduces drift to a near zero level, together with sharpening the 30 m resolution imagery based on the 1 m resolution imagery.

As described above, WV3 imagery was used as the aligned image, which is then used as the base or reference data to generate another output image. The WV3 imagery ID is provided in Table 1 herein. Using WV3 19JUN as the aligned image and DOQQ as the base/reference image, the final image-to-image matching results on drift using the methods described herein are as follows. Zero drift at 49.95% for the entire scene, <=1.7 m (or one-pixel) drift over 93.80% of the entire scene, and 6.20% of the scene remaining for change detection, etc.

FIG. 6 is a plot showing the final iMaG AGR reduced drift database for this analysis. Note that the drift magnitude (y axis) is on a very small scale of 0-9 m. It is advantageous to verify that the final output of the aligned imagery shows substantially no difference from the original base image for the validity of the proposed application modules. As an example of this, four WV3 imagery datasets have been acquired for the Oakland, CA test site as follows:
19JUN18191335-M2AS_R1C1-014140375010_01_P001.TIF
19JUL26191801-M2AS_R1C1-013666705010_01_P001.TIF
19DEC30190958-M2AS_R1C1-013666705020_01_P001.TIF
20FEB18190146-M2AS_R1C1-014140375020_01_P001.TIF

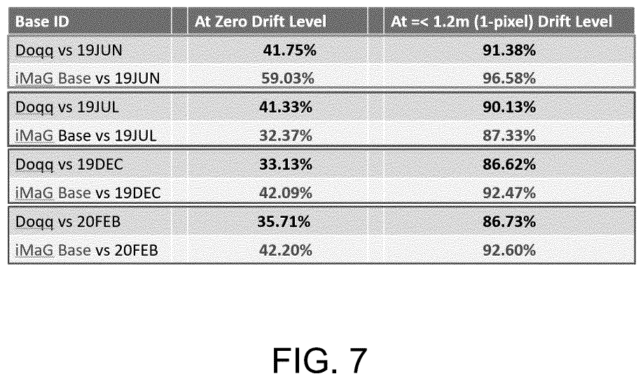

It has been demonstrated above that the output from WV3 19JUN with DOQQ as input is virtually the same as DOQQ geospatially. Therefore, the output from WV3 19JUN can be used as base/reference data to match against other WV3 imagery, e.g., 19JULY, 19DEC and 20FEB. The results of the iMaG AGR automated georegistration method performed on these later datasets with respect to WV3 19JUN are shown in FIG. 7.

A comparison between DOQQ base data and base data consisting of the WV3 19JUN data that has been aligned using the presently-disclosed iMaG AGR automated georegistration method for drift reduction corresponding to four different WV3 scenes is shown in FIG. 7. For 19JUN WV3 data as aligned, the aligned WV3 base performs much better than the DOQQ Base (as shown in the first two lines of FIG. 7). For 19JUL WV3 data as aligned, the iMaG AGR-georegistered 19JUN WV3 base performs slightly worse than the DOQQ Base (as shown in lines 3 and 4 of FIG. 7). For 19DEC data as aligned, the iMaG AGR-georegistered 19JUN WV3 base performs better than the DOQQ Base (as shown in lines 5 and 6 of FIG. 7). Finally, for the 20FEB data as aligned, the iMaG AGR-georegistered 19JUN WV3 base also performs better than the DOQQ Base (as shown in the last 2 lines of FIG. 7).

Thus, in three out of four WV3 examples, the iMaG AGR-georegistered 19JUN WV3 Base performs better than the DOQ Base, particularly at the zero-drift level where they exceeded the 40% level, and for the 1-pixel drift level, they exceeded 90% coverage of the entire scene.

In addition to updating the DOQQ, the near-zero drift matching described herein can be used to fuse very low-resolution imagery, such as 30 m Landsat data, with very high-resolution image data such as the 1 m or better WV3 imagery. The described technique is suitable, e.g., for fusing 30 m hyperspectral imagery of more than 200 bands with 1 m or better WV3 multispectral imagery. Therefore, it is extremely advantageous to fuse high-region literal imagery interpretations with low-resolution non-literal exploitation to take advantages of both the hyperspectral domain and the high-visual photo-interpretation domain.

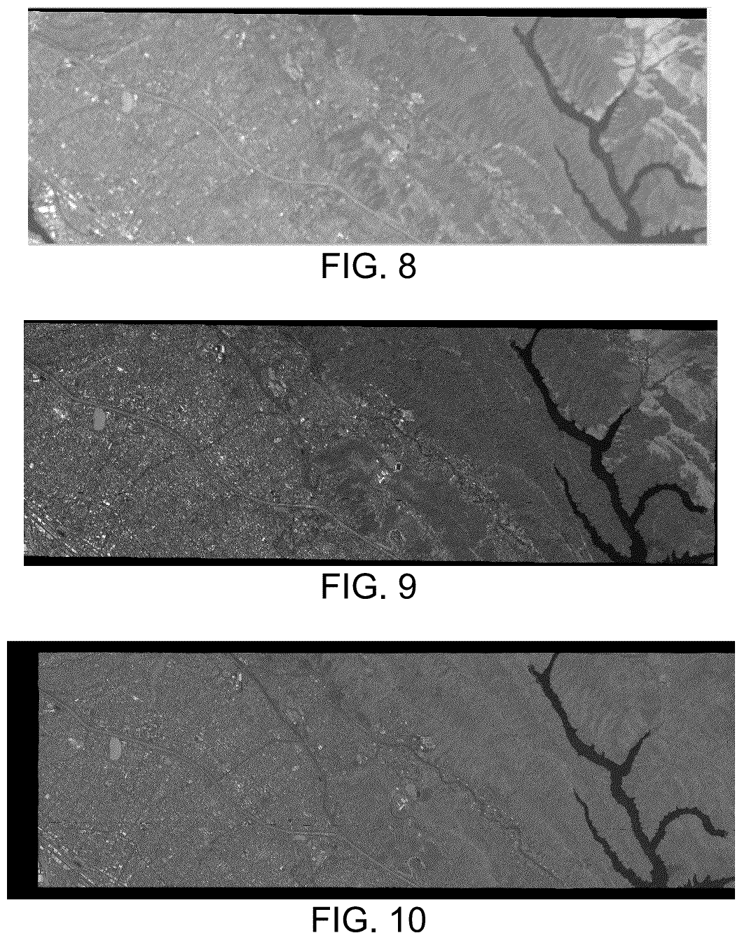

This fusion between 30 m Landsat and 1 m WV3 image data was performed on 2023 Landsat imagery and 2022 WV3 imagery of Oakland, CA. FIG. 8 shows the 30 m resolution of Landsat data covering the Oakland, CA test site, and FIG. 9 is the corresponding June 2022 1 m WV3 imagery.

The image data shown in FIGS. 8 and 9 were georegistered, and drift reduction was then performed to generate a virtually similar image-to-image matched 1 m resolution Landsat imagery. The 30 m Landsat imagery was then sharpened using the 1 m WV3 bands as Pan bands, and the Landsat bands as red, green, blue and NIR bands. The sharpened 1 m Landsat multispectral imagery is shown in FIG. 10.

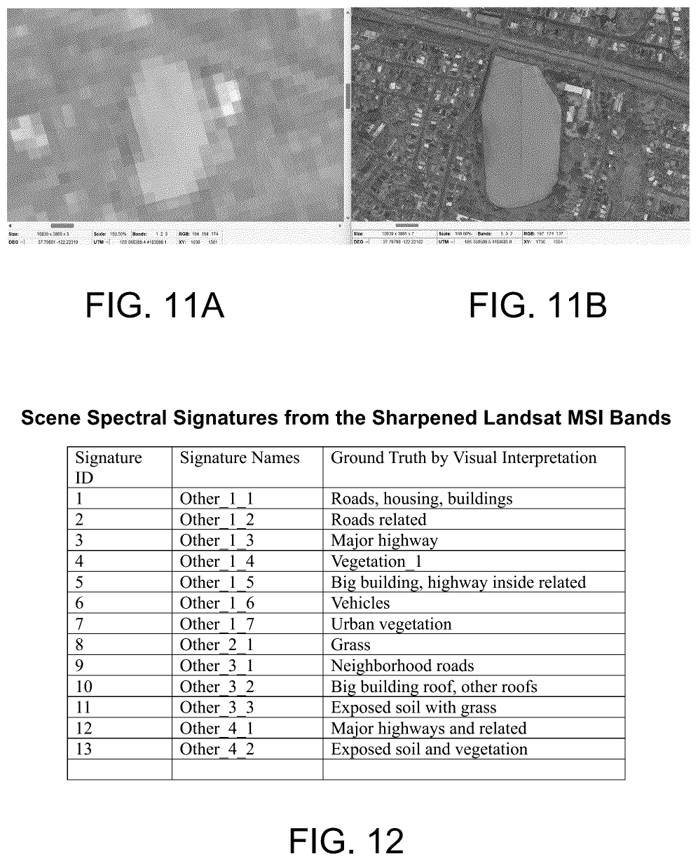

For better visual comparison between the original 30 m Landsat imagery of FIG. 8 and the sharpened 1 m Landsat imagery in FIG. 10, a side-by-side of a closeup region is shown in FIGS. 11A and 11B. FIG. 11A is a magnified image of a particular location from the 30 m Landsat original. FIG. 11B shows this same location in a Landsat image that was sharpened to 1 m resolution using the techniques described herein.

DOQQ imagery is available only for regions within the U.S. However, Landsat 15 m panchromatic images can be used as base images instead of DOQQ worldwide, particularly for regions outside of the U.S. Similar to DOQQ, Landsat images also represent orthoimagery.

Geolocation accuracy has been compared between DOQQ and Landsat imagery at an Oakland, CA test site that covers mountainous, hilly, and urban terrain. The image-to-image matching results between DOQQ and Landsat 15 m pan in a drift histogram shows a min=0 m, average=2.3 m, and max=21.27 m, and the following differences: drift data of zero covering 2.47% of the full scene; drift data of 2.5 m covering 50.79% of the full scene; drift data of 5.0 m covering 92.53% of the full scene; and drift data of 10 m covering 99.54% of the full scene. Because the geospatial accuracy of DOQQ is certified by the U.S. Government as 7.6 m, there is thus no significant difference between DOQQ and Landsat 1.5 m pan in geospatial accuracy.

Noticeable distinctions between the 30 m and 1 m Landsat images (in FIG. 11A and FIG. 11B, respectively) can be made as follows: Roughly similar large object exists at the center of the image. The highways above the large object are clearly visible in the 1 m sharpened image, but can barely be made out in the original 30 m Landsat image. Reddish vegetation in the two images is roughly similar, but much better delineated in the sharpened image. Residential buildings and smaller roadways can be seen clearly in the sharpened image of FIG. 11B, but are not discernible in the original Landsat image of FIG. 11A.

A paper describing the use of fuzzy set methodology for automated target recognition was published in 1999 (S. Yamany, A. A. Farag, and S.-Y. Hsu, Pattern Recognition Letters 20 (1999), 1431-1438). In this paper, the automated extraction of scene contents spectral signatures without the specification of the number of signatures to be extracted was emphasized as a distinction to conventional unsupervised classification for which image analysis needs to be specified by the number of signatures to be extracted. Since 1999, while a rich body of fuzzy set classification has developed, the basic fuzzy theory approach is still primarily an unsupervised approach to classification of scene signatures. Supervised classification and unsupervised classification have been viewed as a gold standard pedagogy. Therefore, it is advantageous to include a supervised classification to fuzzy methodology. In a standard fuzzy classification, there is a tendency to miss small features like ground vehicles, since these small objects were not sampled and included in the classification analyses. Therefore, it is equally advantageous to devise a method to create a region of interest (ROI) to be added to the sampling space to build the scene content signatures. These two new features have now been implemented into the original Yamani/Farag/Hsu fuzzy system methodology, and the modified technique is referred to herein as the managed fuzzy C-Mean, or mfcm, under the iMaG AGR system.

To demonstrate the benefits of mfcm, the image region shown in FIG. 11A (original 30 m Landsat imagery) was used as a region of interest (ROI), and FIGS. 9 and 10 were employed as the full scene to extract scene content signatures from the sharpened Landsat imagery (FIG. 10) and the original unsharpened Landsat multispectral imagery (MSI) (FIG. 9). Specific mfcm system parameters can include, but are not limited to, the following items: the number of bands to be analyzed; the number of iterations; the desired signatures to be extracted; scene signatures drawn from the original setting; the number of signatures in each growing stage; duplicating signatures identifier; fuzzy membership; ROI areas to be included in the analyses; a convergence parameter; and a noise parameter.

It is worth noting that conventional supervised classification is based on a traditional method of classifying unknown pixels into one of the designated training sets plus a reject class. In the iMaG AGR's mfcm system, the ROI areas serve as a form of training sets. Using this technique, there is no need to provide a reject class for the pixels that do not belong to the training sets. Instead, the fuzzy membership approach described herein serves to bring all pixels into one or many classes. Therefore, it is extremely advantageous for classification systems to include membership mapping in addition to the spectral signature mapping.

Conventional supervised classification is based on a traditional method on classifying unknown pixels into one of a set of designated training sets, plus a reject class for nonconforming pixels. In iMaG AGR's mfcm system, the ROI areas serve as form of training sets. One difference in this method is that there is no need to provide a reject class for the pixels that do not belong to the training sets. Instead, the fuzzy membership approach serves as a means to bring all pixels into one or many classes. Therefore, it is extremely advantageous for classification systems to include membership mapping in addition to the spectral signature mapping,

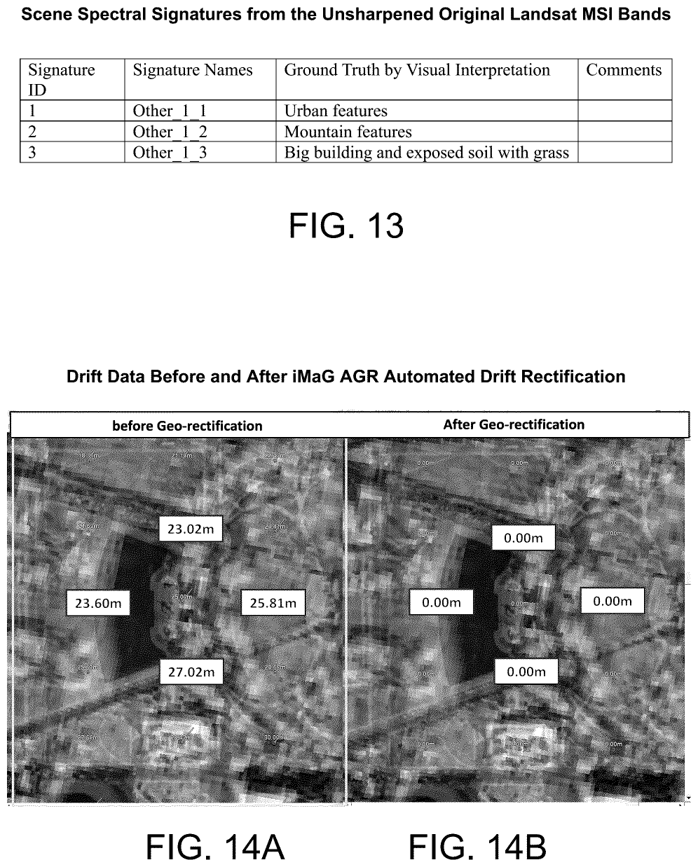

Based on the output of the sharpened Landsat MSI bands, the iMaG AGR's mfcm method generated 13 scene spectral signatures that are listed in the table of FIG. 12. From the output of original unsharpened Landsat MSI imagery, the three resulting scene spectral signatures are listed in the table of FIG. 13. There are distinct differences in the scene spectral signatures between the sharpened and unsharpened Landsat MSI imagery, with much-improved and more varied/detailed spectral signatures obtained from the sharpened Landsat MSI imagery of FIG. 10.

The drift data analyses described above can be performed using an automated drift reduction system that comprises the following steps:
Obtaining image data corresponding to the original non-Ortho Base versus the aligned WV and Pleiades commercial satellite imagery;
Using the iMaG AGR orthorectification methods to perform image rectification on top of the DEM surface;
Performing initial drift reduction based on iMaG ortho imagery; and
Performing a drift reduction that reduces drift to a near zero level as defined herein.

Drift reduction analyses were performed on the Oakland, CA test site where terrain includes mountainous, hilly, and urban areas, and on a Syracuse, NY location comprising primarily flat terrain and urban areas. In both of these test sites, having either >100 m offset or <12 m offset, the iMaG AGR drift reduction methodology was capable of reducing the drift to a near zero level.

Exemplary results of applying the methods described herein above are illustrated in FIGS. 14-16. For example, FIG. 14A is an exemplary image of a region before iMaG AGR automated drift rectification drift showing drift data at certain locations in the image. FIG. 14B is an exemplary image of the same region shown in FIG. 14A after iMaG AGR automated drift rectification showing drift data at the same locations of FIG. 14A. The iMaG AGR automated drift rectification procedure reduces the observed drift from between about 23 m and 27 m at each location to near zero, thus providing a significant drift reduction.

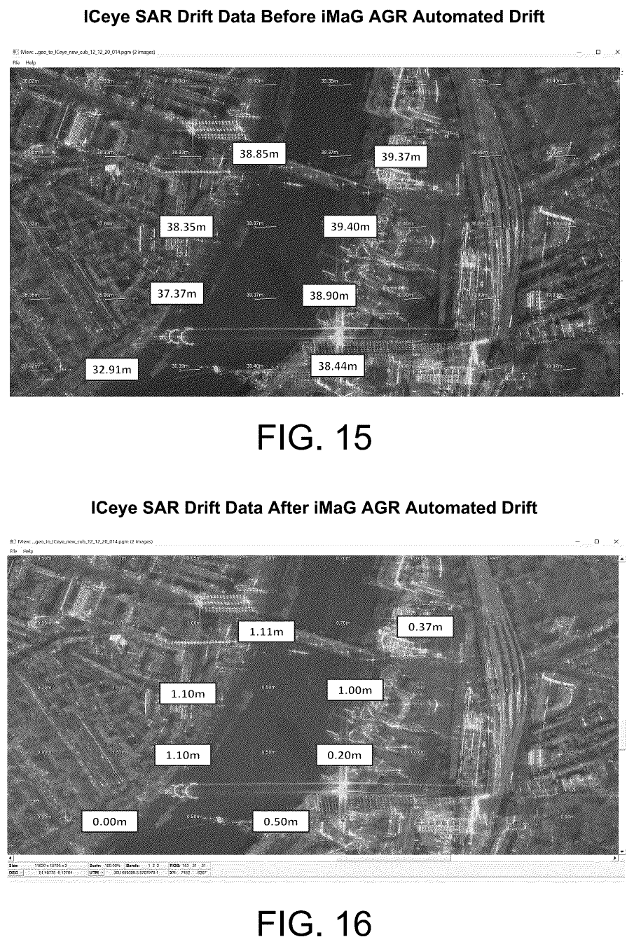

Similarly, FIG. 15 is an exemplary image of a region before iMaG AGR automated drift rectification drift showing ICeye SAR drift data at certain locations in the image. FIG. 16 is an exemplary image of the same region shown in FIG. 15 after iMaG AGR automated drift rectification showing ICeye SAR drift data at the same locations of FIG. 15. The iMaG AGR automated drift rectification procedure reduces the observed ICeye SAR drift from between about 33 m and 40 m at each location to about 1 m at each location, thus providing a significant drift reduction.

This resulting near zero drift level provides an effectively identical copy between the input Base and the output WV imagery and Pleiades NEO imagery. If the input base is DOQQ, there is virtually no difference between DOQQ and WV or Pleiades NEO imagery. Therefore, the output WV imagery or Pleiades NEO imagery from this technique is suitable as input to update DOQQ having acquisition cycles of 2 years, 4 years, or 7 years, thus providing improvement of updating DOQQ in off-acquisition years.

The advantages of using commercial satellite imagery to update DOQQ are as follows: DOQQ becomes a time-continuous coverage of a region of interest (ROI). DOQQ sources can be either airborne or satellite imagery. Once the satellite imagery has gone through the DOQQ process, the satellite imagery becomes ortho imagery that eliminates all the terrain and off-nadir difference effects. DOQQ and commercial satellite imagery can then become the sources for multi-orbit, temporal, and multi-sensor data fusion.

Although the image-to-image georegistration described herein is capable of reducing drift to a near zero level for updating DOQQ, certain obstacles in upstream processing had to be overcome, such as orthorectification and the use of a database to represent the drift across the entire scene surface.

Second, the sources of drift in conventional literature are incomplete. For example, the geolocation accuracy of WV imagery, 3.5 meters, is based on relatively flat terrain. As one example, this accuracy can be obtained at La Crau, France where the topography of La Crau does not exceed 190 m above the reference ellipsoid. This 3.5 m geolocation accuracy is degraded to >100 m in mountainous terrain with >15 degrees of off-nadir difference.

Third, conventional orthorectification is conventionally used to perform geo-inaccuracy rectification, and not to represent drift on the DEM surface. Thus, image-to-image matching is rarely used for drift reduction. In addition, conventional drift reduction is not designed to reduce drift to a zero drift level by a least-squares method. The techniques

The foregoing merely illustrates the principles of the exemplary embodiments of the present disclosure. Other variations to the exemplary embodiments can be understood and effected by those skilled in the art in practising the claimed invention from a study of the drawings, the disclosure, and the appended paragraphs. The mere fact that certain features are described in different paragraphs and/or illustrated in different figures does not indicate that any combination of these features cannot be used advantageously. Various modifications and alterations to the described exemplary embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the present disclosure. Further, all patents, patent applications, publications cited or identified herein are incorporated herein by reference in their entireties.

What is claimed is:

1. A method of reducing multi-orbit drift to a near zero level for automated rectification of geo-inaccuracy in commercial satellite imagery, comprising:
a) obtaining at least two images, one of the images being a base image for scene registration;
b) generating at least one orthorectified image with a corresponding digital elevation model (DEM) in a Virtual Earth Coordinate (VEC);
c) registering the at least one orthorectified image with the base image to produce a registered image set; and
d) outputting the registered image set with scene content signature for at least one of updating USGS digital orthophoto quarter-quadrangle (DOQQ) data, updating Landsat 15 m panchromatic data, or providing multi-resolution, multi-sensor data fusion.

2. The method of claim 1, wherein the registering of the image is automated with at least one aligned imagery chosen from a set thereof consisting of: a) zero drift covering a fraction of the full scene, b) >0 and <1-pixel distance drift covering another fraction of full scene, and c) leaving a small fraction of the full scene for Others.

3. The method of claim 1, wherein the image registration is generated by casting a database representing a set of control points over a full scene in a hierarchical order with at least one level.

4. A method of implementing orthorectification of at least one of satellite or aerial imagery, comprising:
a) inputting the imagery representing a full scene;
b) providing digital elevation model (DEM) data and corresponding rational polynomial coefficients (RPC) data corresponding to the scene; and
c) generating an orthorectified image by casting data corresponding to the at least one of satellite or aerial imagery onto a DEM surface.

5. The method of claim 4, further comprising:
a) generating non-ortho drift data for the at least one of satellite or aerial imagery in csv form;
b) displaying a distribution of the non-ortho drift data in a plot having x-axis coordinates corresponding to a direction of drift, and y-axis coordinates corresponding to a magnitude of the corresponding non-ortho drift data.

6. The method of claim 4, further comprising:
a) generating a further orthorectified image based on a further imagery of the scene;
b) generating ortho drift data in csv form based on a comparison of the orthorectified image and the further orthorectified image;
c) displaying a distribution of the ortho drift data in a plot having x-axis coordinates corresponding to a direction of drift, and y-axis coordinates corresponding to a magnitude of the corresponding non-ortho drift data.

7. A method for updating DOQQ using commercial satellite imagery, the method comprising:
a) obtaining a DOQQ imagery as a base image;
b) obtaining a high-resolution form of the commercial imagery as an aligned image;
c) obtaining digital elevation model data corresponding to the aligned image;
d) obtaining rational polynomial coefficient data for the aligned image;
e) performing an imagery registration using the base image, the digital elevation model data, and the rational polynomial coefficient data to reduce a drift between the base image and the aligned image to a near zero level;
f) using resulting image registration data to update the DOQQ between DOQQ acquisition cycles.

8. A method of fusing multi-resolution geographic imagery and multi-sensor geographic imagery data, comprising:
a) georegistering low-resolution geographic imagery with high-resolution geographic imagery to obtain a georegistered imagery pair, wherein the low-resolution geographic imagery and the high-resolution geographic imagery correspond to a same region;
b) using the georegistered imagery pair as base image and an aligned image to reduce a drift between the base image and the aligned image to a near-zero level;
c) sharpening the resulting near-zero-drift low-resolution imagery using the high-resolution geographic imagery as a pan band, and low-resolution bands as red, green, blue and NIR bands to obtain sharpened low-resolution geographic imagery; and
d) generating an image displaying the sharpened low-resolution geographic imagery.

9. The method of claim 8, wherein the low-resolution geographic imagery comprises low-resolution satellite imagery, and the high-resolution geographic imagery comprises high-resolution satellite imagery.

10. The method of claim 8, wherein the low-resolution geographic imagery comprises low-resolution aerial imagery, and the high-resolution geographic imagery comprises high-resolution aerial imagery.

11. A method of performing scene content analysis to complement between nonliteral exploitation and literal exploitation of multi-spectral and hyperspectral imagery, comprising:
a) georegistering and sharpening a low-resolution imagery between multi-orbit satellite imagery having drift reduced to near zero;
b) performing scene content analysis to optimize a plurality of complementing scene content signatures;
c) comparing characteristics of scene content signatures for both the sharpened low-resolution imagery and the original low-resolution image with higher spectral bands; and
d) output complementary scene content signatures for both the sharpened low-resolution imagery and the original low-resolution image having higher spectral bands.

12. The method of claim 11, wherein each of the scene content signatures is produced by an analysis comprising at least one of the following techniques:
a) a conventional fuzzy set methodology; and
b) a managed fuzzy set methodology based on a specific region of interest.

13. The method of claim 12, wherein the method further comprises providing at least one of spectral signatures or membership scenes for the scene content signatures in a form of a mapping function.

14. The method of claim 12, wherein at least one subsystem used to generate the scene content signatures comprises at least one of:
a number of bands to be analyzed;
a number of iterations used;
a particular signature to be extracted;
a scene signature grown from an original setting;
a number of signatures in each growing stage;
a duplicate signature identifier;
a fuzzy membership;
a region of interest to be included in the scene content analysis;
a convergence parameter; and
a noise parameter.
